(19) United States
(12) Patent Application Publication
(10) Pub. No.: US 2010/0328763 A1
(43) Pub. Date: Dec. 30, 2010

(54) OPTICAL FILTER FOR DISPLAY DEVICE

(75) Inventors: Ji Yoon Seo, ChungCheongNam-Do (KR); Jin Sung Lim, ChungCheongNam-Do (KR); Hong Ik Kim, ChungCheongNam-Do (KR); Dae Chul Park, ChungCheongNam-Do (KR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: SAMSUNG CORNING PRECISION GLASS CO., LTD., Gyeongsangbuk-do (KR)

(21) Appl. No.: 12/822,620

(22) Filed: Jun. 24, 2010

(30) Foreign Application Priority Data
Jun. 26, 2009 (KR) 10-2009-0057571

(51) Int. Cl. F21V 9/04

(52) U.S. Cl. 359/359

(57) ABSTRACT

An optical filter for a display device can be provided with excellent fracture strength without using heat-treated tempered glass. The optical filter is used in the display device having a display module therein and is disposed in front of the display module. The optical filter includes an annealed glass substrate, an optical film laminated on the surface of one side of the annealed glass substrate, and a protective layer formed on the surface of the other side of the annealed glass substrate. The protective layer serves to prevent a substance from being eluted from inside the annealed glass substrate.

### CROSS REFERENCE TO RELATED APPLICATION

The present application claims priority from Korean Patent Application Number 10-2009-0057571 filed on Jun. 26, 2009, the entire contents of which are incorporated herein for all purposes by this reference.

### BACKGROUND OF THE INVENTION

1. Field of the Invention

The present invention relates to an optical filter for a display device and, more particularly, to an optical filter for a display device which can be provided with excellent fracture strength without using heat-treated tempered glass.

2. Description of Related Art

In the process of manufacturing plate glass, fine substances, which are not decomposed, may be included in the glass while the glass passes through a melting furnace and a cooling furnace. Such inclusions may cause the glass to easily fracture. The worst such inclusion is nickel sulfide. The nickel sulfide may be created when nickel particulates are bonded with sulfur, which is included in the fuel of the melting furnace, or with the material of a glass storage vessel. It is impossible to completely remove the nickel sulfide particulates since they are very fine, having a diameter less than 0.4 mm. Therefore, all glass includes nickel sulfide to some extent. When the glass is heat treated, the nickel sulfide inclusion is transformed depending on time and temperature. If the nickel sulfide inclusion is located in a tight portion in the center of the glass, its expansion can produce sufficient stress to cause damage to the glass. That is, the nickel sulfide inclusion expands at a higher rate than the glass, thereby causing the glass to spontaneously fracture.

In particular, during the rapid cooling in the process of tempering the glass, the nickel sulfide (NiS), which has a higher heat expansion rate than the glass, expands inside the glass, leaving fine cracks in some portions of the surface of a niche wall (i.e., the interface between the glass and the inclusion, or a so-called glass niche). The nickel sulfide (NiS) continuously and gradually transits into the β phase, even after it has cooled to room temperature, thereby increasing the pressure applied to the niche wall along with an increase in the volume thereof. This, as a result, increases cracks created during the tempering process and, ultimately, causes the glass to fracture suddenly.

Recently, in response to the development of parts related to photoelectronics, particularly, image display devices, various devices for providing digital information, such as a TV monitor, a PC monitor, and an information display panel provided in a bus or a subway, have become widely distributed. Such display devices employ optical filters that include a variety of optical films in order to improve the performance with regard to external light reflection, luminance, contrast, afterimage, viewing angle, color purity, and the like. Such an optical filter employs heat-treated tempered glass for protection from external impacts.

Due to the above-mentioned problems, in the display device industry, a variety of attempts are being made in order to obtain an optical filter without using the tempered glass. One of the goals is to reduce the total weight of the final product by removing the tempered glass and instead, directly attaching a component optical film to a display panel. However, in practice, it is impossible to provide sufficient strength against noise generated from the panel and external impacts.

Due to these practical difficulties, the display device industry is attempting to obtain an optical filter having excellent fracture strength by using annealed glass instead of tempered glass. However, when annealed glass is exposed to moisture or air for a long time, the elution of sodium ions (Na⁺) weakens the strength of the surface of the glass and causes the surface of the glass to become hazy and dim. Therefore, in the related art, the elution of sodium ions (Na⁺) has been prevented by attaching or adhering an antireflection film on the front side of the glass and attaching or adhering a variety of optical films on the rear side of the annealed glass.

However, as the display market is gradually expanding and price competition in the market is becoming more intensive, display providers are trying to lower the costs of manufacturing the optical filter by excluding the use of the antireflection film or other optical films in order to attain superior market competitiveness.

The information disclosed in this Background of the Invention section is only for the enhancement of understanding of the background of the invention, and should not be taken as an acknowledgment or any form of suggestion that this information forms a prior art that would already be known to a person skilled in the art.

### BRIEF SUMMARY OF THE INVENTION

Various aspects of the present invention provide an optical filter for a display device that has excellent fracture strength without using heat-treated tempered glass.

Also provided is an optical filter for a display device that can improve visibility of image and reduce manufacturing costs.

The optical filter for a display device is used in a display device having a display module therein and is disposed in front of the display module. In an aspect of the present invention, the optical filter includes an annealed glass substrate, an optical film laminated on the surface of one side of the annealed glass substrate, and a protective layer formed on the surface of the other side of the annealed glass substrate. The protective layer serves to prevent a substance from being eluted from inside the annealed glass substrate.

In another aspect of the present invention, the optical film may include an Electromagnetic Interference (EMI) shielding layer and a color correction layer formed on the EMI shielding layer. The EMI shielding layer serves to block Electromagnetic radiation emitted from the display module, and the color correction layer serves to improve the characteristics of light emitted from the display module.

According to the exemplary embodiments of the present invention as set forth above, the optical filter can be obtained by forming the protective layer, which prevents a substance from being eluted from the surface of the annealed glass substrate, which is exposed to the outside, and forming the optical film on the opposite surface. This configuration can prevent, for example, an increase in haze due to the elution of sodium ion (Na⁺) from inside the annealed glass substrate, thereby resulting in the production of an optical filter that has excellent visibility and fracture strength.

In addition, the optical filters according to the exemplary embodiments of the invention satisfy filter standards for the display device even if the optical film includes only the EMI shielding layer and the color correction layer. Accordingly, the manufacturing costs of the optical filter can be reduced.

The methods and apparatuses of the present invention have other features and advantages which will be apparent from, or are set forth in more detail in the accompanying drawings, which are incorporated herein, and in the following Detailed Description of the Invention, which together serve to explain certain principles of the present invention.

### BRIEF DESCRIPTION OF THE DRAWINGS

FIG. 1 schematically shows the structure of a display device to which an optical filter for a display device according to an exemplary embodiment of the invention is applied; and

FIG. 2 schematically shows an optical filter for a display device according to an exemplary embodiment of the invention.

### DETAILED DESCRIPTION OF THE INVENTION

Reference will now be made in detail to various embodiments of the present invention(s), examples of which are illustrated in the accompanying drawings and described below, so that the scope of the invention can be fully conveyed to a person of ordinary skill in the art. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments that may be included within the spirit and scope of the invention as defined by the appended claims.

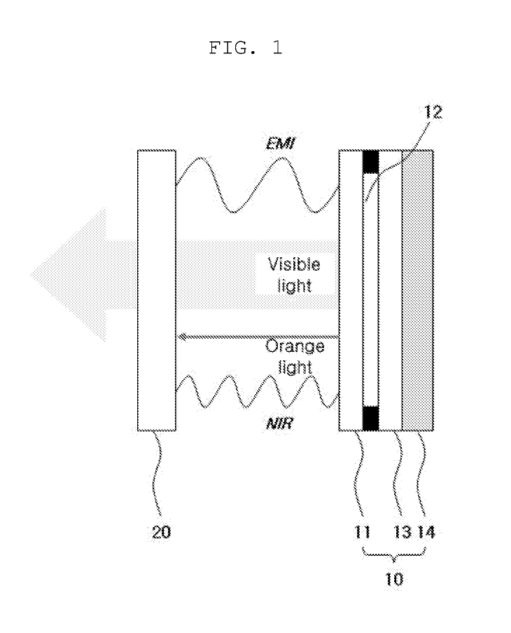

FIG. 1 schematically shows the structure of a display device to which an optical filter for a display device according to an exemplary embodiment of the invention is applied.

Referring to FIG. 1, the display device according to this exemplary embodiment may be a Plasma Display Panel (PDP) device. The PDP device generally includes a display module 10 and an optical filter 20, which is disposed in front of the display module 10.

The display module 10 has discharge cells 12 between a first substrate 11 and a second substrate 13. The discharge cells 12 are filled with a mixed gas of Ne and Xe. In addition, a fluorescent substance is applied on the inner side of the first substrate 11 and the second substrate 13. In the PDP device, when a strong electric field is applied to the mixed gas contained in the discharge cells 12 via a drive circuit 14, Ultraviolet (UV) radiation emitted from the mixed gas collides with the fluorescent substance, thereby generating visible light, Electromagnetic radiation (EMI), Near Infrared (NIR) radiation, and orange light, which lowers color purity.

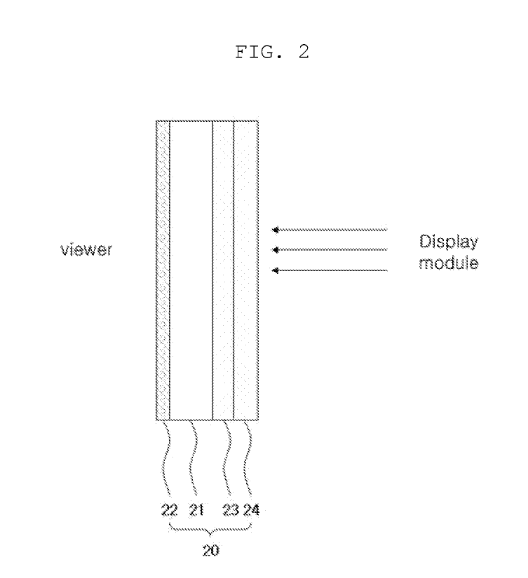

The optical filter 20 serves to block Electromagnetic radiation, NIR radiation, and orange light, thereby protecting the body of a viewer, preventing external devices, such as a remote controller, from malfunctioning, and improving color purity. Below, with reference to FIG. 2, a description will be given of the structure of an optical filter 20 for a display device according to an exemplary embodiment of the invention.

FIG. 2 schematically shows an optical filter for a display device according to an exemplary embodiment of the invention.

As shown in the figure, the optical filter 20 includes an annealed glass substrate 21, a protective layer 22, and an optical film. The optical film includes an EMI shielding layer 23, and a color correction layer 24.

The protective layer 22 is provided on the side of the annealed glass substrate 21 that faces the viewer, and serves to prevent substances, for example, sodium ions (Na⁺), from being eluted from inside the annealed glass substrate 21. For example, the protective layer 22 can include SnO₂. The SnO₂ may be obtained by floating molten glass on a bed of molten tin to give the glass uniform thickness and very flat surfaces. In this float glass process, the SnO₂ is adhered to the surface of the annealed glass substrate 21 that is in contact with the molten tin.

The EMI shielding layer 23 serves to block Electromagnetic radiation emitted from the display module. The EMI shielding layer can include a multilayer conductive film that includes a plurality of metal thin films and a plurality of high-refractivity transparent thin films, which are alternately laminated. As an alternative, the EMI shielding layer 23 can include a conductive mesh of metal.

Here, the conductive mesh may be an earthed metal mesh, a metal-coated synthetic resin mesh or a metal-coated metal fiber mesh. As a metal material forming the conductive mesh, any metal, which has excellent electric conductivity and processability, such as copper, chromium, nickel, silver, molybdenum, tungsten, or aluminum, can be used.

In the multilayer conductive film, the high-refractivity transparent thin film may be made of Indium Tin Oxide (ITO), indium oxide, stannic oxide, zinc oxide, or the like. The metal thin film may be made of copper, platinum, palladium, or the like.

The color correction layer 24 is formed on the EMI shielding layer 23, and serves to improve the characteristics of light emitted from the display module. The color correction layer 24 performs a color correction function of changing or controlling color balance by reducing or adjusting the amounts of red (R) light, green (G) light, and blue (B) light. The color correction layer 24 can be formed by directly coating a resin which contains a color correction colorant therein, on the surface of the EMI shielding layer 23.

The color correction layer 24 can be formed to include a neon-cut colorant so that it can perform a neon-cut function. Red visible light, generated from plasma inside the display panel, generally tends to become orange. The neon-cut colorant changes such orange light, having a wavelength range from 580 nm to 600 nm, into red light.

The color correction layer 24 increases the color reproduction range of display and improves the clarity of image. Such colorants may include dyes or pigments. The colorants may include organic colorants, such as anthraquinone-based colorants, cyanine-based colorants, styryl based colorants, phthalocyanine-based colorants, and methane-based colorants, which have a neon-cut function. The type and concentration of the colorants are not limited to specific dimensions, since they are determined by the absorption wavelength, absorption coefficient, and transmittance characteristics required for display.

The color correction layer may contain a NIR absorbing colorant therein. The NIR absorbing colorant may include one or more selected from among mixed colorants in which nickel complex and diimonium are mixed, compound colorants containing copper ion and zinc ion, cyanine-based colorants, anthraquinone-based colorants, squarylium-based compounds, azomethine-based compounds, oxysonol compounds, azo-based compounds, benzylidene-based compounds, and the like

Although it has been described herein that the protective layer 22 is located on the side of the annealed glass substrate 21 that faces the viewer and the optical film 23 and 24 are located on the other side of the annealed glass substrate 21, which faces the display module, the present invention is not limited thereto. That is, the protective layer 22 may be located on the side of the annealed glass substrate 21 that faces the display module, whereas the optical film 23 and 24 may be located on the other side of the annealed glass substrate 21, which faces the viewer.

Table 1 below presents the results of a DU impact test of UL6500, for optical filters for a display device according to an exemplary embodiment of the invention. Here, each of the optical filters was produced by forming an protective layer including SnO₂ on one side of the annealed glass substrate, which is exposed to the outside, that is, faces the viewer, and then forming an EMI shielding layer and a color correction layer on the opposite side of the annealed glass substrate. An iron ball having a diameter of 51 mm and a weight of 540 g was used to apply the impact to the optical filters, and glass fracture strengths were tested with changing the height (i.e., potential energy) from the optical filters.

TABLE 1

| | | Result of fracture strength test of glass | | | | |
|---|---|---|---|---|---|---|
| Height | Energy | Sample | Sample | Sample | Sample | Sample |
| (mm) | (J) | 1 | 2 | 3 | 4 | 5 |
| 500 | 2.65 | ∘ | ∘ | ∘ | ∘ | ∘ |
| 800 | 4.23 | ∘ | ∘ | ∘ | ∘ | ∘ |
| 1000 | 5.29 | ∘ | ∘ | ∘ | ∘ | ∘ |
| 1300 | 6.88 | ∘ | ∘ | ∘ | ∘ | ∘ |
| 1500 | 7.94 | ∘ | ∘ | ∘ | x | ∘ |
| 1800 | 9.53 | ∘ | ∘ | ∘ | — | ∘ |

As presented in Table 1, from a test for 5 optical filters for a display device, it was observed that Sample 4 was fractured but the other samples were not fractured by fracture energy of 6.88 J or more. Considering that the fracture strength required for home appliances is generally 3.5 J, it can be appreciated that the optical filters according to the exemplary embodiments of the invention have good fracture strength.

The foregoing descriptions of specific exemplary embodiments of the present invention have been presented for the purposes of illustration and description so that the scope of the invention can be fully conveyed to a person of ordinary skill in the art. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable a person of ordinary skill in the art to make and utilize various exemplary embodiments of the present invention, as well as various alternatives and modifications thereof. It is intended that the scope of the invention be defined by the Claims appended hereto and their equivalents.

What is claimed is:

1. An optical filter, which is used in a display device having a display module therein and is disposed in front of the display module, the optical filter comprising:
an annealed glass substrate;
an optical film laminated on a surface of one side of the annealed glass substrate; and
a protective layer formed on a surface of the other side of the annealed glass substrate, wherein the protective layer prevents a substance from being eluted from inside the annealed glass substrate.

2. The optical filter according to claim 1, wherein the protective layer comprises SnO₂.

3. The optical filter according to claim 2, wherein the annealed glass substrate is a float glass and the SnO₂ is adhered to the float glass.

4. The optical filter according to claim 1, wherein the optical film comprises:
an electromagnetic interference shielding layer blocking electromagnetic radiation emitted from the display module; and
a color correction layer correcting color of light emitted from the display module.

5. The optical filter according to claim 4, wherein the electromagnetic interference shielding layer comprises a conductive mesh or a conductive film, wherein the conductive film comprises a plurality of metal thin films and a plurality of high-refractivity transparent thin films, which are alternately laminated.

6. The optical filter according to claim 4, wherein the color correction layer comprises at least one of a near infrared absorbing colorant and a neon-cut colorant.
